(19) United States
(12) Patent Application Publication
(10) Pub. No.: US 2026/0254272 A1
(43) Pub. Date: Aug. 27, 2026

(54) Self-Powered Remote Control Method and Device Based on Low-Light Energy Harvesting

(71) Applicant: Guodong Cai, Shenzhen (CN)

(72) Inventor: Guodong Cai, Shenzhen (CN)

(21) Appl. No.: 19/266,146

(22) Filed: Jul. 10, 2025

(30) Foreign Application Priority Data
Feb. 26, 2025 (CN) 202510214617.1

(51) Int. Cl. H02J 50/00; H02J 7/34; H02J 7/35; H02J 50/30

(52) U.S. Cl. CPC H02J 50/001; H02J 7/345; H02J 7/35; H02J 50/30; H02J 2207/50

(57) ABSTRACT

The invention involves the low-light power generation and self-powered technology field, providing a self-powered remote control method and device based on low-light energy harvesting. The device comprises: a low-light energy harvesting unit collecting ambient light source energy and converting the energy into electrical energy; an energy conversion unit converting the electrical energy into stable direct current; an energy storage unit storing the direct current; a remote control unit utilizing the current stored in the energy storage unit to provide power, achieving control of a target device. The invention can operate continuously in low-brightness environments, relying solely on low-light to achieve self-powering, providing stable power supply for low-power devices such as remote controls, solving the problem existing low-light power generation technologies failing to adequately address energy collection and storage for low-power devices in indoor or dim environments, and avoiding transportation, cost, and environmental pollution issues caused by traditional batteries.

### TECHNICAL FIELD

The present invention relates to the field of low-light power generation and self-powered technology, specifically to a self-powered remote control method and device based on low-light energy harvesting.

### BACKGROUND ART

With the widespread application of low-power devices, particularly the proliferation of small devices such as remote controls, the use of traditional batteries presents numerous issues. Existing batteries typically require frequent replacement, and the pollution caused during battery recycling is increasingly severe. In particular, common lithium batteries require strict recycling and processing after their lifespan expires, otherwise they release harmful substances, polluting the environment.

Low-light power generation technology, as the name suggests, is a technology that utilizes weak light sources for power generation. Although existing low-light power generation technologies can operate under weak illumination conditions, they mostly rely on stronger light sources (such as sunlight) for effective energy harvesting. For low-power devices in indoor or dim environments, existing technologies have not adequately addressed the challenges of energy harvesting and storage.

### SUMMARY OF PRESENT INVENTION

In view of this, to address the shortcomings of existing low-light power generation technologies in energy harvesting and storage for low-power devices in indoor or dim environments, the present invention provides a self-powered remote control method and device based on low-light energy harvesting. It can utilize weak ambient light sources (such as indoor lighting, natural scattered light, etc.) for energy harvesting, converting and storing the energy to provide stable power for low-power devices (such as remote controls). This avoids transportation, cost, and environmental pollution issues associated with traditional batteries, offering advantages of environmental friendliness, long-term stable power supply, and low cost. The specific technical solutions are as follows:

A self-powered remote control method based on low-light energy harvesting, comprising the following steps:
Provide a low-light energy harvesting unit, through the low-light energy harvesting unit collect ambient light source energy and convert said light source energy into electrical energy;
Provide an energy conversion unit, through the energy conversion unit convert said electrical energy into stable direct current;
Provide an energy storage unit, through the energy storage unit store said direct current;
Provide a remote control unit, through the electrical energy stored in said energy storage unit provide power to the remote control unit and achieve control of a target device.

The self-powered remote control method based on low-light energy harvesting collects ambient light source energy through the low-light energy harvesting unit and converts said light source energy into electrical energy, converts it into direct current through the energy conversion unit, and stores the electrical energy through the energy storage unit. It can operate continuously in low-brightness environments, relying solely on low-light to achieve self-powering, providing stable power supply for low-power devices such as remote controls. This solves the problem of existing low-light power generation technologies failing to adequately address energy harvesting and storage for low-power devices in indoor or dim environments, avoiding transportation, cost, and environmental pollution issues caused by traditional batteries.

Preferably, the self-powered remote control method based on low-light energy harvesting further includes the following steps:
Acquire a storage wakeup threshold and the remaining energy of said energy storage unit, based on the storage wakeup threshold and remaining energy construct a sleep duration attenuation term;
Acquire an energy variation trend of said light source energy and a sleep duration correction factor, based on said energy variation trend and sleep duration correction factor construct a sleep duration correction term, so that when said light source energy increases, the value of said sleep duration correction term increases, and when said light source energy decreases;
Based on said sleep duration attenuation term and sleep duration correction term construct a dynamic sleep duration adjustment mechanism for said remote control unit;

Wherein, the greater the difference between said remaining energy and the storage wakeup threshold, the smaller the value of said sleep duration attenuation term.

Preferably, the specific method for acquiring said sleep duration correction factor includes the following steps:
Acquire the energy distribution complexity within a preset time period;

Based on said energy distribution complexity acquire said sleep duration correction factor.

Preferably, through a wireless signal transmission module communicate with the target device, utilizing the electrical energy stored in the energy storage unit for signal transmission and target device control.

A self-powered remote control device based on low-light energy harvesting, for implementing said self-powered remote control method based on low-light energy harvesting, comprising:
A low-light energy harvesting unit, for collecting ambient light source energy and converting said light source energy into electrical energy;
An energy conversion unit, for converting said electrical energy into stable direct current; An energy storage unit, for storing said direct current;

A remote control unit, for utilizing the electrical energy stored in said energy storage unit to provide power, achieving control of a target device.

The self-powered remote control device based on low-light energy harvesting said collects the ambient light source energy through a said low-light energy harvesting unit and converts it said light source energy into electrical energy, converts it into direct current through the an energy conversion unit, and stores the electrical energy through the an energy storage unit. It can operate continuously in low-brightness environments, relying solely on low-light to achieve self-powering, providing stable power supply for low-power devices such as remote controls. This solves the problem of existing low-light power generation technologies failing to adequately address energy harvesting and storage for low-power devices in indoor or dim environments, avoiding transportation, cost, and environmental pollution issues caused by traditional batteries.

Preferably, the self-powered remote control device based on low-light energy harvesting further includes:

A sleep duration attenuation term construction unit, for acquiring a storage wakeup threshold and the remaining energy of said energy storage unit, based on the storage wakeup threshold and remaining energy constructing a sleep duration attenuation term;

A sleep duration correction term construction unit, for acquiring the energy variation trend of said light source energy and a sleep duration correction factor, based on said energy variation trend and sleep duration correction factor constructing a sleep duration correction term, so that when said light source energy increases, the value of said sleep duration correction term increases, and when said light source energy decreases, the value of said sleep duration correction term decreases;

A dynamic sleep duration adjustment mechanism construction unit, for constructing based on said sleep duration attenuation term and sleep duration correction term a dynamic sleep duration adjustment mechanism for said remote control unit;

Wherein, the greater the difference between said remaining energy and the storage wakeup threshold, the smaller the value of said sleep duration attenuation term.

Preferably, the sleep duration correction term construction unit includes:

An energy distribution complexity acquisition subunit, for acquiring the energy distribution complexity within a preset time period;

A sleep duration correction factor acquisition subunit, for acquiring said sleep duration correction factor based on said energy distribution complexity.

Preferably, the low-light energy harvesting unit is at least one photodiode or photocell array, and the energy conversion unit adopts an energy conversion chip.

Preferably, the energy storage unit is a high-capacity capacitor, and said high-capacity capacitor is a supercapacitor or lithium-ion capacitor.

Preferably, the self-powered remote control device based on low-light energy harvesting further includes:

A wireless signal transmission module, for sending remote control signals, achieving functional control of the target device.

### DESCRIPTION OF THE DRAWINGS

The present invention can be further understood from the following description in conjunction with the accompanying drawings. The components in the drawings are not necessarily drawn to scale, but rather focus on illustrating the principles of the embodiments. In different views, identical reference numerals designate corresponding parts.

FIG. 1 is a schematic diagram of the overall process of a self-powered remote control method based on low-light energy harvesting in one embodiment of the present invention;

FIG. 2 is a schematic diagram of the process of a self-powered remote control method based on low-light energy harvesting in another embodiment of the present invention;

FIG. 3 is a schematic diagram of the specific method for acquiring the sleep duration correction factor in one embodiment of the present invention;

FIG. 4 is a schematic diagram of the overall structure of a self-powered remote control device based on low-light energy harvesting in one embodiment of the present invention;

FIG. 5 is a schematic diagram of the relationship between low-light harvesting and energy conversion in one embodiment of the present invention.

### DETAILED DESCRIPTION OF EMBODIMENTS

To make the objectives, technical solutions, and advantages of the present invention clearer, the present invention is further described in detail below with reference to its embodiments. It should be understood that the specific embodiments described herein are only used to explain the present invention and do not limit the scope of protection of the present invention.

It should be noted that when an element is referred to as being “fixed to” another element, it may be directly on the other element or there may also be an intervening element. When an element is considered to be “connected” to another element, it may be directly connected to the other element or there may also be an intervening element. The terms “vertical,” “horizontal,” “left,” “right,” and similar expressions used herein are for illustrative purposes only and do not indicate the only implementation.

Unless otherwise defined, all technical and scientific terms used herein have the same meaning as commonly understood by those skilled in the technical field of the present invention. The terms used in the specification of the present invention herein are only for the purpose of describing specific embodiments and are not intended to limit the present invention. The term “and/or” as used herein includes any and all combinations of one or more related listed items.

The terms “first” and “second” in the present invention do not represent specific quantities or sequences but are merely used for distinguishing names.

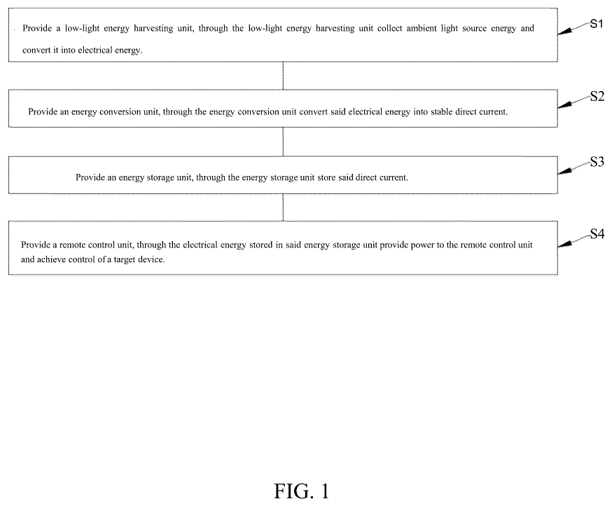

As shown in FIG. 1, one embodiment of the present invention provides a self-powered remote control method based on low-light energy harvesting, including the following steps:

S1. Provide a low-light energy harvesting unit, through the low-light energy harvesting unit collect ambient light source energy and convert said light source energy into electrical energy.

The low-light energy harvesting unit consists of a photodiode or photocell array, capable of efficiently collecting weak light energy under low-light sources (such as indoor lighting, scattered sunlight from windows, etc.) and converting the light energy into electric current.

S2. Provide an energy conversion unit, through the energy conversion unit convert said electrical energy into stable direct current.

The energy conversion unit consists of a highly efficient energy conversion chip, which converts electrical energy into stable direct current and transmits the direct current to the energy storage unit.

S3. Provide an energy storage unit, through the energy storage unit store said direct current.

The energy storage unit adopts high-capacity capacitors such as supercapacitors or lithium-ion capacitors, which have high energy storage density and longer service life, capable of storing energy for extended periods at low voltages.

S4. Provide a remote control unit, through the electrical energy stored in said energy storage unit provide power to the remote control unit and achieve control of a target device.

The remote control unit can communicate with the target device through a wireless signal transmission module (such as infrared, radio frequency, Bluetooth, etc.), utilizing the electrical energy stored in the energy storage unit for signal transmission and target device control, i.e., using the power provided by the energy storage unit to perform functional control of the target device, such as switching or adjustment.

The self-powered remote control method based on low-light energy harvesting collects ambient light source energy through the low-light energy harvesting unit and converts said light source energy into electrical energy, converts it into direct current through the energy conversion unit, and stores the electrical energy through the energy storage unit. It can operate continuously in low-brightness environments, relying solely on low-light to achieve self-powering, providing stable power supply for low-power devices such as remote controls. This solves the problem of existing low-light power generation technologies failing to adequately address energy harvesting and storage for low-power devices in indoor or dim environments, avoiding transportation, cost, and environmental pollution issues caused by traditional batteries. Compared with existing technologies, the self-powered remote control method based on low-light energy harvesting described in the present invention has lower usage costs, a longer service life, and higher environmental friendliness.

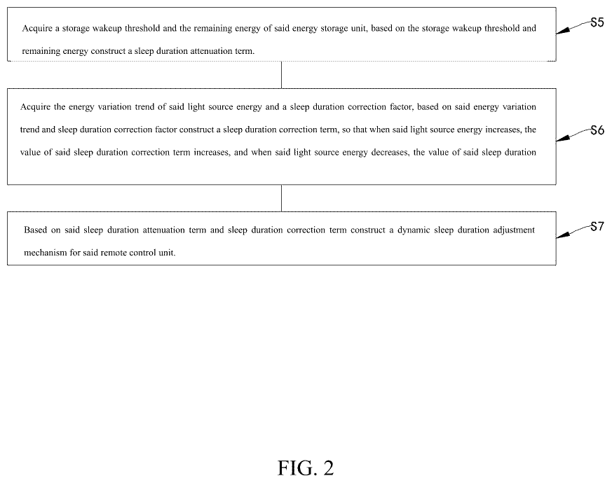

As a preferred technical solution, as shown in FIG. 2, the self-powered remote control method based on low-light energy harvesting further includes the following steps:

S5. Acquire a storage wakeup threshold and the remaining energy of said energy storage unit, based on the storage wakeup threshold and remaining energy construct a sleep duration attenuation term.

Specifically, the greater the difference between said remaining energy and the storage wakeup threshold, the smaller the value of said sleep duration attenuation term. Preferably, the sleep duration attenuation term is an exponential attenuation term, which adjusts the base sleep duration based on the energy storage state of the energy storage unit. The closer the remaining energy is to the storage wakeup threshold, the shorter the sleep duration, ensuring rapid system response when remaining energy is sufficient, and extending sleep duration when remaining energy is low, thereby prolonging the system's service life.

More specifically,

$$the sleep duration attenuation term = {T}_{0} \times {e}^{- \frac{{E}_{store}}{{E}_{threshold}}} ;$$

where where T₀ represents the base sleep duration, e represents the natural constant, Eₛₜₒᵣₑ represents the remaining energy, and E_{threshold} represents the storage wakeup threshold. For the storage wakeup threshold E_{threshold}, it can be set to 1.5 times the energy consumption of a single complete operating cycle of the system, optimized using Monte Carlo simulation. The energy consumption of a single complete operating cycle of the system can be the energy consumption at a selected time node, preferably the average energy consumption over N time nodes.

Specifically, by introducing an exponential decay model for sleep duration, it can replace traditional linear threshold judgments, avoiding frequent wakeups of the energy storage unit in the critical energy region.

S6. Acquire the energy variation trend of said light source energy and a sleep duration correction factor, based on said energy variation trend and sleep duration correction factor construct a sleep duration correction term, so that when said light source energy increases, the value of said sleep duration correction term increases, and when said light source energy decreases, the value of said sleep duration correction term decreases.

Specifically, the sleep duration correction term=τ×sgn(∇E); where τ represents the sleep duration correction factor, and sgn ( ) represents the sign function.

Based on the energy variation trend, the sign adjusts the sleep offset, i.e., adjusts the magnitude of the sleep duration correction term. When the energy is in an upward trend (∇E>0), the sleep duration is extended; when in a downward trend (∇E<0), the sleep duration is shortened. Thus, by incorporating the dynamic characteristics of energy harvesting, the limitations of traditional static sleep strategies can be overcome.

For the energy variation trend ∇E, a sliding time window (e.g., 10 seconds) is used to calculate the energy change rate, avoiding interference from instantaneous fluctuations.

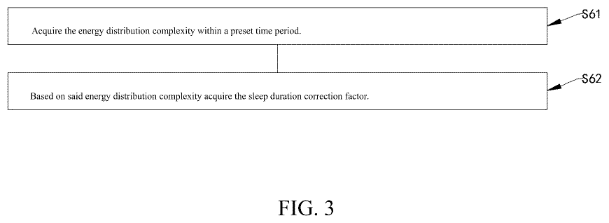

Preferably, as shown in FIG. 3, in step S6, the specific method for acquiring the sleep duration correction factor includes the following steps:

S61. Acquire the energy distribution complexity within a preset time period. The energy distribution complexity

$${H}_{E} = {\sum }_{i = 1}^{N} ( - {p}_{i} ln {p}_{i} ) ,$$

where N represents the number of time nodes within the preset time period, pᵢ represents the energy distribution probability of the i th time node, and satisfies

$${\sum }_{i = 1}^{N} {p}_{i} = 1$$

through normalization; the time nodes within the preset time period can be set by technicians, for example, setting the preset time period to one day with the number of time nodes set to 24, and the energy distribution probability of a certain time node is the ratio of the total energy consumption within a preset time width before and after that time node to the total energy consumption of the day.

It can be understood that when

$${H}_{E} = {\sum }_{i = 1}^{N} ( - {p}_{i} ln {p}_{i} )$$

approaches 0, the energy distribution of the N time nodes within the preset time period is highly concentrated, with a single time node occupying most of the energy. When H_{E}→ln N, the energy distribution of the N time nodes within the preset time period is uniform.

S62. Acquire the sleep duration correction factor based on said energy distribution complexity.

Preferably, τ=k·H_{E}, where k represents the system sensitivity, which can be set by technicians based on experience. Using the energy distribution complexity

$${H}_{E} = {\sum }_{i = 1}^{N} ( - {p}_{i} ln {p}_{i} )$$

as a dynamic adjustment parameter for the sleep duration correction factor, it enables dynamic adjustment of the sleep duration based on energy entropy

$${H}_{E} = {\sum }_{i = 1}^{N} ( - {p}_{i} ln {p}_{i} ) ,$$

achieving more refined sleep scheduling control. In high-entropy states, the sleep duration correction factor is amplified, extending the sleep duration to reduce energy consumption from frequent wakeups. In low-entropy states, the sleep duration correction factor is reduced, prioritizing system response speed.

S7. Based on said sleep duration attenuation term and sleep duration correction term, construct a dynamic sleep duration adjustment mechanism for said remote control unit. Specifically, the dynamic sleep duration adjustment mechanism can be understood as

$${T}_{sleep} = {T}_{0} \times {e}^{- \frac{{E}_{store}}{{E}_{threshold}}} + τ \times sgn ( ∇ E ) ;$$

where Tₛₗₑₑₚ represents the total sleep duration.

By constructing said dynamic sleep duration adjustment mechanism, the self-powered remote control method described in the present invention reduces wakeup latency by more than 30% compared to traditional fixed sleep strategies, and at an illumination of 200 lx, the system's static power consumption can be controlled within 3 μA.

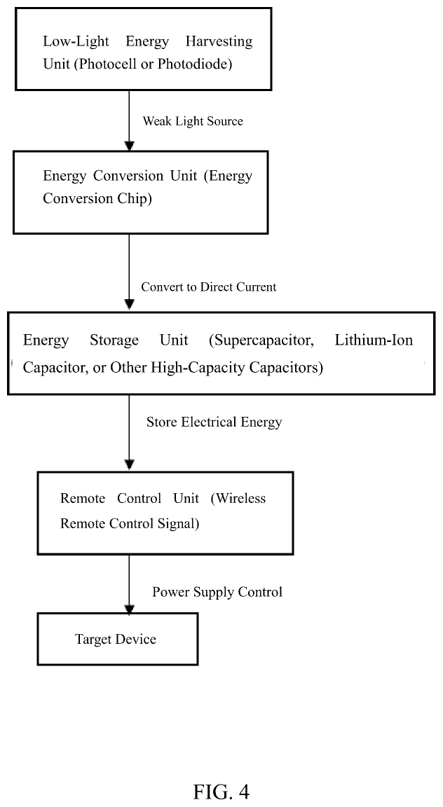

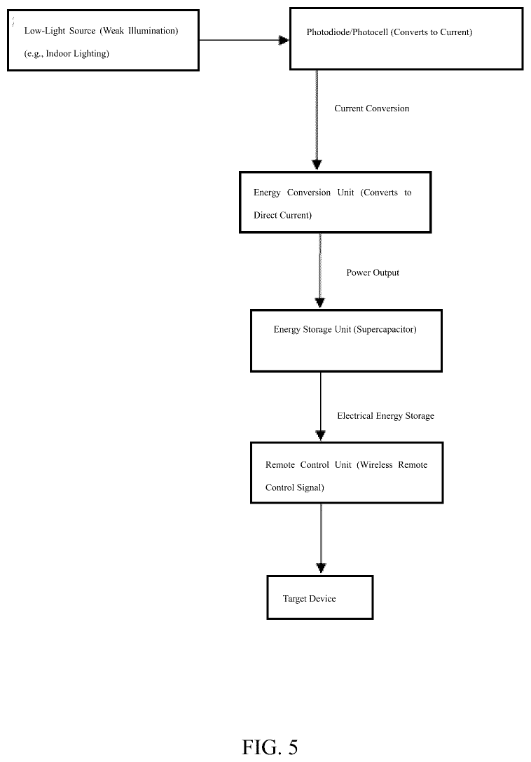

One embodiment of the present invention also provides a self-powered remote control device based on low-light energy harvesting, as shown in FIGS. 4 and 5, for implementing said self-powered remote control method based on low-light energy harvesting, comprising a low-light energy harvesting unit, an energy conversion unit, an energy storage unit, and a remote control unit.

The low-light energy harvesting unit is used to collect ambient light source energy and convert said light source energy into electrical energy.

This unit consists of a photodiode or photocell array, capable of efficiently collecting light energy in low-light environments. Regardless of the direction of the light source, the photodiode can be installed on the front or back of the device housing and effectively convert ambient light.

Each photodiode can convert weak light energy into photocurrent and is connected to the energy conversion unit through a conductive circuit.

Preferably, said low-light energy harvesting unit can operate under weak illumination conditions and is disposed on the front, back, sides, both front and back, multiple surfaces including front, back, and sides, or other multiple surfaces of the device to enhance energy harvesting efficiency.

The energy conversion unit is used to convert said electrical energy into stable direct current. The energy conversion unit adopts a highly efficient energy conversion chip, capable of converting the energy collected by the low-light energy harvesting unit into direct current. This conversion unit has high conversion efficiency, ensuring stable current output even under weak light sources. The current is transmitted to the energy storage unit for subsequent use.

The energy storage unit is used to store said direct current, employing supercapacitors, lithium-ion capacitors, or similar for energy storage. Compared to traditional batteries, supercapacitors and lithium-ion capacitors have a longer service life and higher energy density. Through supercapacitors, the system can store energy for extended periods at low voltages, avoiding the charging cycles and pollution issues associated with traditional lithium batteries.

The remote control unit is used to utilize the electrical energy stored in said energy storage unit to provide power, achieving control of a target device. Preferably, said self-powered remote control device based on low-light energy harvesting further includes a wireless signal transmission module, which is used to send remote control signals, achieving functional control of the target device.

The remote control unit adopts wireless remote control technology (such as radio frequency, infrared, Bluetooth, etc.), capable of receiving and sending remote control signals, and sends signals to the target device through the wireless signal transmission module. The device relies on stored electrical energy, requiring no external power source, thus having low maintenance costs.

The self-powered remote control device based on low-light energy harvesting collects ambient light source energy through the low-light energy harvesting unit and converts said light source energy into electrical energy, converts it into direct current through the energy conversion unit, and stores the electrical energy through the energy storage unit. It can operate continuously in low-brightness environments, relying solely on low-light to achieve self-powering, providing stable power supply for low-power devices such as remote controls. This solves the problem of existing low-light power generation technologies failing to adequately address energy harvesting and storage for low-power devices in indoor or dim environments, avoiding transportation, cost, and environmental pollution issues caused by traditional batteries.

Compared with existing technologies, the self-powered remote control method described in the present invention has lower usage costs, a longer service life, and higher environmental friendliness, while avoiding the hassle of battery replacement, offering broad application prospects.

Based on the self-powered remote control device described in this embodiment, it has the following features: 1. Environmental Friendliness: Completely eliminates battery pollution, with supercapacitors, lithium-ion capacitors, and other high-capacity capacitors having a lifespan >10 years; 2. Economy: Costs are at least 60% lower than lithium battery solutions, requiring no maintenance; 3. Practicality: Under indoor lighting, natural scattered light, etc., the device can meet self-powering requirements.

As a preferred technical solution, said self-powered remote control device based on low-light energy harvesting further includes a sleep duration attenuation term construction unit, a sleep duration correction term construction unit, and a dynamic sleep duration adjustment mechanism construction unit.

The sleep duration attenuation term construction unit is used to acquire a storage wakeup threshold and the remaining energy of said energy storage unit, based on the storage wakeup threshold and remaining energy constructing a sleep duration attenuation term.

The sleep duration correction term construction unit is used to acquire the energy variation trend of said light source energy and a sleep duration correction factor, based on said energy variation trend and sleep duration correction factor constructing a sleep duration correction term, so that when said light source energy increases, the value of said sleep duration correction term increases, and when said light source energy decreases, the value of said sleep duration correction term decreases.

The dynamic sleep duration adjustment mechanism construction unit is used to construct, based on said sleep duration attenuation term and sleep duration correction term, a dynamic sleep duration adjustment mechanism for said remote control unit;

Wherein, the greater the difference between said remaining energy and the storage wakeup threshold, the smaller the value of said sleep duration attenuation term.

Preferably, said sleep duration correction term construction unit includes an energy distribution complexity acquisition subunit and a sleep duration correction factor acquisition subunit.

The energy distribution complexity acquisition subunit is used to acquire the energy distribution complexity within a preset time period; the sleep duration correction factor acquisition subunit is used to acquire said sleep duration correction factor based on said energy distribution complexity.

Specifically,

$$the sleep duration attenuation term = {T}_{0} \times {e}^{- \frac{{E}_{store}}{{E}_{threshold}}} ;$$

where T₀ represents the base sleep duration, e represents the natural constant, Eₛₜₒᵣₑ represents the remaining energy, and E_{threshold} represents the storage wakeup threshold. For the storage wakeup threshold E_{threshold}, it can be set to 1.5 times the energy consumption of a single complete operating cycle of the system (for example, the energy consumption at a selected time node, preferably the average energy consumption over N time nodes), optimized using Monte Carlo simulation. By introducing an exponential decay model for sleep duration, it can replace traditional linear threshold judgments, avoiding frequent wakeups of the energy storage unit in the critical energy region.

The sleep duration correction term=τ×sgn(∇E); where τ represents the sleep duration correction factor, and represents sgn ( ) the sign function. Based on the energy variation trend, the sign adjusts the sleep offset, i.e., adjusts the magnitude of the sleep duration correction term. When the energy is in an upward trend (∇E>0), the sleep duration is extended; when in a downward trend (∇E<0), the sleep duration is shortened. Thus, by incorporating the dynamic characteristics of energy harvesting, the limitations of traditional static sleep strategies can be overcome. For said energy variation trend ∇E, a sliding time window (e.g., 10 seconds) is used to calculate the energy change rate, avoiding interference from instantaneous fluctuations.

The energy distribution complexity

$${H}_{E} = {\sum }_{i = 1}^{N} ( - {p}_{i} ln {p}_{i} ) ,$$

where N represents the number of time nodes within the preset time period, pᵢ represents the energy distribution probability of the i th time node, and satisfies

$${\sum }_{i = 1}^{N} {p}_{i} = 1$$

through normalization; the time nodes within the preset time period can be set by technicians, for example, setting the preset time period to one day with the number of time nodes set to 24, and the energy distribution probability of a certain time node is the ratio of the total energy consumption within a preset time width before and after that time node to the total energy consumption of the day. It can be understood that when

$${H}_{E} = {\sum }_{i = 1}^{N} ( - {p}_{i} ln {p}_{i} )$$

approaches 0, the energy distribution of the N time nodes within the preset time period is highly concentrated, with a single time node occupying most of the energy. When H_{E}→ln N, the energy distribution of the N time nodes within the preset time period is uniform.

The sleep duration correction factor τ=k·H_{E}, where k represents the system sensitivity, which can be set by technicians based on experience. Using the energy distribution complexity

$${H}_{E} = {\sum }_{i = 1}^{N} ( - {p}_{i} ln {p}_{i} )$$

as a dynamic adjustment parameter for the sleep duration correction factor, it enables dynamic adjustment of the sleep duration based on energy entropy

$${H}_{E} = {\sum }_{i = 1}^{N} ( - {p}_{i} ln {p}_{i} ) ,$$

achieving more refined sleep scheduling control. In high-entropy states, the sleep duration correction factor is amplified, extending the sleep duration to reduce energy consumption from frequent wakeups. In low-entropy states, the sleep duration correction factor is reduced, prioritizing system response speed.

The dynamic sleep duration adjustment mechanism can be understood as

$${T}_{sleep} = {T}_{0} \times {e}^{- \frac{{E}_{store}}{{E}_{threshold}}} + τ \times sgn ( ∇ E ) ;$$

where Tₛₗₑₑₚ represents the total sleep duration.

By constructing said dynamic sleep duration adjustment mechanism, the self-powered remote control method described in the present invention reduces wakeup latency by more than 30% compared to traditional fixed sleep strategies, and at an illumination of 200 lx, the system's static power consumption can be controlled within 3 μA.

The technical features of the embodiments described above can be arbitrarily combined. To keep the description concise, not all possible combinations of the technical features in the above embodiments are described. However, as long as there is no contradiction in the combination of these technical features, they shall be considered within the scope of this specification.

The embodiments described above only represent several implementations of the present invention, with their descriptions being relatively specific and comprehensive, but they should not be construed as limiting the scope of the invention patent. It should be noted that, for those of ordinary skill in the art, without departing from the concept of the present invention, several variations and improvements can be made, all of which fall within the scope of protection of the present invention. Therefore, the scope of protection of the present invention patent shall be subject to determined by the appended claims.

1. A self-powered remote control method based on low-light energy harvesting, comprising:
provide a low-light energy harvesting unit, through the low-light energy harvesting unit collect ambient light source energy and convert the light source energy into electrical energy; wherein the low-light energy harvesting unit is at least one photodiode or photocell array, and is configured to collect weak light energy under low-light sources and convert the weak light energy into electric current; the low-light sources comprises indoor lighting or scattered sunlight from windows;
provide an energy conversion unit, through the energy conversion unit convert the electrical energy into stable direct current;
provide an energy storage unit, through the energy storage unit store the direct current;
provide a remote control unit, through the electrical energy stored in the energy storage unit provide power to the remote control unit and achieve control of a target device.

2. The self-powered remote control method based on low-light energy harvesting according to claim 1, wherein further comprises:
acquire a storage wakeup threshold and a remaining energy of the energy storage unit, based on the storage wakeup threshold and remaining energy to construct a sleep duration attenuation term;
acquire an energy variation trend of the light source energy and a sleep duration correction factor, based on the energy variation trend and sleep duration correction factor to construct a sleep duration correction term, so that when the light source energy increases, a value of the sleep duration correction term increases, and when the light source energy decreases, the value of the sleep duration correction term decreases;
based on the sleep duration attenuation term and sleep duration correction term to construct a dynamic sleep duration adjustment mechanism for the remote control unit;
wherein, with greater a difference between the remaining energy and the storage wakeup threshold, with smaller the value of the sleep duration attenuation term.

3. The self-powered remote control method based on low-light energy harvesting according to claim 2, wherein a specific method for acquiring the sleep duration correction factor comprises:
acquire the energy distribution complexity within a preset time period;
based on the energy distribution complexity acquire the sleep duration correction factor.

4. The self-powered remote control method based on low-light energy harvesting according to claim 3, wherein through a wireless signal transmission module communicate with the target device, utilizing the electrical energy stored in the energy storage unit for signal transmission and target device control.

5. A self-powered remote control device based on low-light energy harvesting, comprising:
a low-light energy harvesting unit, for collecting ambient light source energy and converting the light source energy into electrical energy; wherein the low-light energy harvesting unit is at least one photodiode or photocell array, and is configured to collect weak light energy under low-light sources and convert the weak light energy into electric current; the low-light sources comprises indoor lighting or scattered sunlight from windows;
an energy conversion unit, for converting the electrical energy into stable direct current;
an energy storage unit, for storing the direct current;
a remote control unit, for utilizing the electrical energy stored in the energy storage unit to provide power, achieving control of a target device.

6. The self-powered remote control device based on low-light energy harvesting according to claim 5, wherein further comprises:
a sleep duration attenuation term construction unit, for acquiring a storage wakeup threshold and a remaining energy of the energy storage unit, based on the storage wakeup threshold and remaining energy constructing a sleep duration attenuation term;
a sleep duration correction term construction unit, for acquiring an energy variation trend of the light source energy and a sleep duration correction factor, based on the energy variation trend and sleep duration correction factor constructing a sleep duration correction term, so that when the light source energy increases, a value of the sleep duration correction term increases, and when the light source energy decreases, the value of the sleep duration correction term decreases;
a dynamic sleep duration adjustment mechanism construction unit, for constructing based on the sleep duration attenuation term and sleep duration correction term a dynamic sleep duration adjustment mechanism for the remote control unit;
wherein, with greater a difference between the remaining energy and the storage wakeup threshold, with smaller the value of the sleep duration attenuation term.

7. The self-powered remote control device based on low-light energy harvesting according to claim 6, wherein the sleep duration correction term construction unit comprises:
an energy distribution complexity acquisition subunit, for acquiring the energy distribution complexity within a preset time period;
a sleep duration correction factor acquisition subunit, for acquiring the sleep duration correction factor based on the energy distribution complexity.

8. The self-powered remote control device based on low-light energy harvesting according to claim 7, wherein the energy conversion unit adopts an energy conversion chip.

9. The self-powered remote control device based on low-light energy harvesting according to claim 8, wherein the energy storage unit is a high-capacity capacitor, and the high-capacity capacitor is a supercapacitor or lithium-ion capacitor.

10. The self-powered remote control device based on low-light energy harvesting according to claim 9, wherein the self-powered remote control device based on low-light energy harvesting further comprises:
a wireless signal transmission module, for sending remote control signals, achieving functional control of the target device.
